(19) United States
(12) Patent Application Publication
(10) Pub. No.: US 2021/0141987 A1
(43) Pub. Date: May 13, 2021

(54) METHOD FOR ADAPTING CONFIGURATION PARAMETERS FOR AN ELECTRONIC DEVICE AND AN ELECTRONIC DEVICE

(71) Applicant: Sony Corporation, Tokyo (JP)

(72) Inventors: Jimmy ENGSTROM, Dalby (SE); Hannes BERGKVIST, Helsingborg (SE)

(21) Appl. No.: 17/067,682

(22) Filed: Oct. 10, 2020

(30) Foreign Application Priority Data
Nov. 11, 2019 (SE) 1951298-7

(51) Int. Cl. G06F 30/27

(52) U.S. Cl. CPC G06F 30/27; G06F 2119/06

(57) ABSTRACT

An electronic device is disclosed, the electronic device comprises a memory circuitry and a processor circuitry comprising a simulation circuitry, an inference circuitry, and a learning circuitry. The electronic device comprises an interface circuitry. The processor circuitry is configured to obtain first primary sensor data from a sensor circuitry. The processor is configured to generate, based on the first primary sensor data, simulated prediction data at the simulation circuitry. The processor is configured to generate, based on the first primary sensor data, first prediction data at the inference circuitry. The processor is configured to generate, based on the simulated prediction data, second prediction data at the inference circuitry. The processor is configured to generate, based on the first prediction data and the second prediction data, a set of configuration parameters at the learning circuitry. The processor is configured to provide, to the sensor circuitry, the set of configuration parameters.

### RELATED APPLICATION DATA

This application claims the benefit of Swedish Patent Application No. 1951298-7 filed on Nov. 11, 2019, the disclosure of which is incorporated herein by reference in its entirety.

### TECHNICAL FIELD

The present disclosure pertains to the field of Internet of things, and relates to an electronic device and to a method for adapting one or more configuration parameters for an electronic device.

### BACKGROUND

Power optimization is a challenging aspect of the design of electronic devices such as connected devices and Internet of things, IoT, devices. It may be challenging to reduce energy consumption of electronic devices for example to ensure that a battery powered electronic device may be working for its intended operation time. Many electronic devices comprise sensors that are configured to be interrupt-enabled. These sensors usually have a dormant state of low power consumption until an event occurs. A common scenario is that an electronic device sleeps until a sensor interrupt occurs, and then performs some processing of data obtained from the sensors.

An interrupt logic may be determined by a series of configuration parameters. These configuration parameters are tuned manually to achieve a tradeoff between too many wake-ups (higher power consumption) and too few wake-ups (missing relevant events). It may be challenging and time consuming to tune these configuration parameters and it requires expert level competence. The results are often less than optimal due to differences in the lab environment compared to the real life conditions or deployment environment. It may be challenging to foresee and adjust for every possible sensor situation.

### SUMMARY

For example, the configuration parameters tuned in the lab environment may require large margins to avoid false negatives (missing actual events) when deployed.

Accordingly, there is a need for electronic devices and methods for adapting one or more configuration parameters for electronic devices, which mitigate, alleviate or address the shortcomings existing and provide a more reliable, and precise provision of configuration parameters to one or more sensor circuitries operatively coupled to an electronic device.

The present disclosure provides an electronic device. The electronic device comprises a memory circuitry and a processor circuitry comprising a simulation circuitry, an inference circuitry, and a learning circuitry. The electronic device comprises an interface circuitry. The processor circuitry is configured to obtain first primary sensor data from a sensor circuitry. The processor is configured to generate, based on the first primary sensor data, simulated prediction data at the simulation circuitry. The processor is configured to generate, based on the first primary sensor data, first prediction data at the inference circuitry. The processor is configured to generate, based on the simulated prediction data, second prediction data at the inference circuitry. The processor is configured to generate, based on the first prediction data and the second prediction data, a set of configuration parameters at the learning circuitry. The processor is configured to provide, to the sensor circuitry, the set of configuration parameters. The electronic device is configured to perform any of the methods disclosed herein.

Further, a method for adapting one or more configuration parameters for an electronic device is provided. The electronic device comprises a memory circuitry, an interface circuitry, and a processor circuitry comprising a simulation circuitry, an inference circuitry, and a learning circuitry. The method comprises obtaining first primary sensor data from a sensor circuitry. The method comprises generating, based on the first primary sensor data, simulated prediction data at the simulation circuitry. The method comprises generating, based on the first primary sensor data, first prediction data at the inference circuitry. The method comprises generating, based on the simulated prediction data, second prediction data at the inference circuitry. The method comprises generating, at the learning circuitry, based on the first prediction data and the second prediction data, a set of configuration parameters. The method comprises providing, to the sensor circuitry, the set of configuration parameters.

It is an advantage of the present disclosure that the power consumption of the electronic device may be reduced. This may be achieved by optimizing the set of configuration parameters to reduce unnecessary triggerings and/or wake ups of the processing at the electronic device.

Further, an advantage of the present disclosure is that the optimization may be done by running simulation operations at a higher rate than the first primary sensor data is obtained, thereby learning the optimal values for the sensor circuitry faster than without the disclosed technique.

An advantage of the present disclosure is that the false wake-ups of the electronic device may be reduced, and thereby improving the power consumption of the electronic device.

The above advantages may provide a more reliable and more precise electronic device and provision of configuration parameters for sensor circuitries operatively coupled with the electronic device. In other words, the disclosed electronic device and method allow on-device, continuous adaptation and optimization of the configuration parameters (for example sensor chipset interrupt parameter) by exploiting the simulation circuitry, the inference circuitry, and the learning circuitry.

### BRIEF DESCRIPTION OF THE DRAWINGS

The above and other features and advantages of the present disclosure will become readily apparent to those skilled in the art by the following detailed description of example embodiments thereof with reference to the attached drawings, in which:

FIG. 1A is a block diagram illustrating an example electronic device according to this disclosure,

FIG. 1B is a block diagram illustrating an example electronic device according to this disclosure,

FIG. 2 is a flow-chart illustrating an example method, for adapting one or more configuration parameters for an electronic device, and

FIG. 3 is a diagram illustrating an example process for adapting one or more configuration parameters according to one or more embodiments of this disclosure.

### DETAILED DESCRIPTION

Various example embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

FIG. 1A is a block diagram illustrating an example electronic device 300A according to some embodiments of the present disclosure.

The electronic device 300A may for example comprise a portable electronic device, a wireless device, and/or an IoT device.

The electronic device 300A comprises a memory circuitry 301, a processor circuitry 302 comprising a simulation circuitry 302A, an inference circuitry 302B, and a learning circuitry 302C. The simulation circuitry 302A, the inference circuitry 302B, and the learning circuitry 302C may be seen as a virtual sensor logic and possibly one or more inference models (such as one or more pretrained domain models).

The electronic device 300A comprises an interface circuitry 303. In some embodiments, the interface circuitry 303 may be configured to operatively connect the electronic device to an external network, for example wirelessly and/or through a wired connection.

The processor circuitry 302 is configured to obtain first primary sensor data from a sensor circuitry. In one or more example electronic devices, the sensor circuitry is internal to the electronic device 300A. In other words, the electronic device 300A may comprise the sensor circuitry 304A. The first primary sensor data may be data such as accelerometer data from a sensor circuitry such as an accelerometer, light data from a photo-sensor, sound (such as voice) data from a microphone, photo or video data from a camera, temperature data from a thermometer, pressure data from a pressure sensor, and/or humidity data from a hygrometer.

Optionally, the sensor circuitry may comprise one or more of: an accelerometer, photo-sensor, a microphone, a camera, a thermometer, a pressure sensor, and a hygrometer. For example, the sensor circuitry may be set to generate events at one or more thresholds (such as the smallest threshold possible).

In some embodiments, the processor circuitry 302 may be configured to obtain first primary sensor data and first secondary sensor data from the sensor circuitry 304A acting as a first sensor circuitry (such as first primary accelerometer data, being indicative of for example an acceleration and first secondary accelerometer data, being indicative of for example an orientation).

In some embodiments, the processor circuitry 302 may be configured to obtain first primary sensor data from the sensor circuitry 304A acting as a first sensor circuitry (such as first primary accelerometer data, being for example a first acceleration) and second primary sensor data from a second sensor circuitry (such as second primary sound data, being for example a first sound).

The processor circuitry 302 is configured to generate, based on the first primary sensor data, simulated prediction data at the simulation circuitry 302A. The simulation circuitry 302A may be seen as a simulation engine configured to emulate and/or simulate a sensor logic based on one or more configurations to generate the simulated prediction data (for example simulated sensor data, for example obtained based on interrupt parameter(s) and/or threshold logic parameter(s)). The simulation prediction data may for example be seen as based on simulated hardware logic data of a sensor circuitry. The simulation prediction data may for example be seen simulated sensor data, such as simulated first primary sensor data. For example, the simulation prediction data may be seen as obtained based on simulated sensor data. In other words, the simulation prediction data may be seen as data obtained from simulation of the sensor logic to predict the sensor logic behaviour under a given set of configuration parameters (such as a slightly adjusted set of configuration parameters) and based on the first primary sensor data.

For example, if the simulation circuitry 302A determines that the first primary sensor data exceeds a simulated configuration parameter (such as simulated interrupt threshold), the simulation circuitry 302A generates the simulated prediction data and provides the simulated prediction data to the inference circuitry 302B (and eventually to the learning circuitry 302C).

The processor circuitry 302 is configured to generate, based on the first primary sensor data, first prediction data at the inference circuitry 302B. The inference circuitry 302B is optionally configured to provide the first prediction data to an operating system of the sensor circuitry and/or of the electronic device. The first prediction data may be seen as data resulting from applying an inference model (such as an optimization algorithm) to the first primary sensor data. For example, the first prediction data may be indicative of a prediction of a likelihood that an actual event is detected based on the first primary sensor and an inference model.

The processor circuitry 302 is configured to generate, based on the simulated prediction data, second prediction data at the inference circuitry 302B. The second prediction data may be seen as data resulting from applying an inference model to the simulated prediction data. For example, the second prediction data may be indicative of a prediction of a likelihood that an actual event is detected based on the simulated prediction data and an inference model.

In one or more example electronic devices, the inference circuitry 302B comprises a first inference circuitry 302BB. In one or more example electronic devices, the generation of the first prediction data at the inference circuitry 302B is further based on a first inference model associated with the first inference circuitry 302BB.

In one or more example electronic devices, the inference circuitry 302B comprises a second inference circuitry 302BC. In one or more example electronic devices, the generation of the first prediction data at the inference circuitry 302B is further based on a second inference model associated with the second inference circuitry 302BC.

In one or more example electronic devices, the inference circuitry 302B comprises a third inference circuitry. In one or more example electronic devices, the generation of the first prediction data at the inference circuitry 302B is further based on a third inference model associated with the third inference circuitry.

The first inference model, the second inference model, and the third inference model may be seen as a first inference layer, a second inference layer, and a third inference layer. The layers may act as recurring layers.

The first inference model, the second inference model, and the third inference model may be seen as a first inference layer, a second inference layer, and a third inference layer. The inference layers may act as recurring layers.

The first inference layer may be indicative of a first state of the inference circuitry, the second inference layer may be indicative of a second state of the inference circuitry, and the third layer may be indicative of a third state of the inference circuitry. The states may for example be a dormant state, an active state, a passive state, a wake-up state, and/or an awake state. The states may be related to different levels of complexity of the inference model at the inference circuitry. In other words, a state may be seen as a class.

The inference circuitry 302B may be seen as an inference engine configured to perform an inference (such as an inference derivation, such as a statistical inference, such as a statistical inference derivation) such as based on an inference model. The inference engine may for example perform or run predictions using both first primary sensor data (such as real data from the sensor circuitry 304A, such as raw sensor data from the sensor circuitry 304A) and simulated prediction data (such as simulated sensor data). In some embodiments, the inference circuitry may be configured as a black-box element, for example as an element of which operations are not transparent to an entity external to the black-box element (for example the inference circuitry is black-boxed from an engineer's viewpoint). In some embodiments, it may be envisaged that the simulation may be a result of feeding data (such as the first primary sensor data and the simulated prediction data) through the inference circuitry and observing the results over time.

The electronic device 300A and/or the interface circuitry 303 may comprise a proxy circuitry configured to route first primary sensor data to one or more of: inference circuitry and simulation circuitry. For example, the proxy circuitry is configured to route (optionally split) the first primary data (such as a first primary data stream) to both the inference circuitry and the simulation circuitry.

The processor circuitry 302 is configured to generate, based on the first prediction data and the second prediction data, a set of configuration parameters at the learning circuitry 302C. In some embodiments, the learning circuitry 302C may be seen as a learning engine configured to tune the set of configuration parameters. The learning circuitry may for example be configured to store the learned data on the memory circuitry. A configuration parameter may be seen as a parameter used to configure operations of the sensor circuitry. The set of configuration parameters may comprise one or more configuration parameters.

The processor circuitry 302 is configured to provide, to the sensor circuitry, the set of configuration parameters. In some embodiments, the processor circuitry may be configured to control the sensor circuitry based on the set of configuration parameters.

The disclosed electronic device permits reducing the time consuming aspect of tuning configuration parameters and increasing performance. For example, when tracking packages, the electronic device may benefit from a low power consumption to ensure that it is working during the full transport. To reduce energy consumption, electronic devices uses for example an accelerometer sensing to wake up the electronic device. An inference engine runs to classify if it was a real movement, which is very energy consuming. From an engineering viewpoint, an optimized configuration (for example an optimized wake-up threshold on the accelerometer sensor) leads to a reduced activity of the inference engine. This requires a balance between waking up too often (and consuming more energy) and missing important events.

The set of configuration parameters may comprise a set of hardware parameters (such as hardware interrupt parameters). The hardware interrupt parameters may for example update existing hardware interrupt parameters in the sensor circuitry. In other words, the set of configuration parameters from the learning circuitry may be optimized and tuned parameters that may replace the existing set of configuration parameters in the sensor circuitry. The set of configuration parameters from the learning circuitry may comprise one or more threshold values. The threshold values may be optimized at the learning circuitry, according to a theoretical optimal value obtained at a given time t. In some embodiments, the one or more threshold values provided as configuration parameters, may be determined such that a safety margin is kept, compared to the theoretical optimal value.

The set of configuration parameters may comprise a set of software parameters (such as software parameters of the sensor circuitry). For example, in speech recognition, the software parameters may comprise a keyword detection parameter, a sentence parameter, and/or a voice parameter.

In one or more example electronic devices, the processor circuitry 302 is configured to obtain, at the simulation circuitry 302A, the set of configuration parameters from the learning circuitry 302C.

In one or more example electronic devices, the processor circuitry 302 is configured to generate the simulated prediction data based on the first primary sensor data and the obtained set of configuration parameters.

In some embodiments, the learning circuitry 302C may be seen as a learning engine configured to tune the simulated prediction data.

In some embodiments, the learning circuitry may be configured to provide a set of configuration parameters to the simulation circuitry. In some embodiments, the learning circuitry may be configured to provide the set of configuration parameters to both the sensor circuitry and the simulation circuitry. The learning circuitry may provide a set of configuration parameters simultaneously and/or at different times. The set of configuration parameters provided to the sensor circuitry and set of configuration parameters provided to the simulation circuitry may be different set of configuration parameters, such as a first set of configuration parameters and a second set of configuration parameters (such as having different values). In other words, the learning circuitry may be configured to provide an additional set of configuration parameters to the simulator circuitry.

In one or more example electronic devices, the generation of the set of configuration parameters at the learning circuitry 302C is based on a comparison of the first prediction data and the second prediction data. For example, the first prediction data and the second prediction data are compared to generate the set of configuration parameter (such as an updated set). For example, if the first prediction data matches substantially with the second prediction data, the set of configuration parameters provided to the simulation circuitry 302A is increased. For example, if the first prediction data does not match substantially with the second prediction data, the set of configuration parameters provided to the simulation circuitry 302A is decreased. In other words, for example, if the first prediction data validates the second prediction data, the set of configuration parameters provided to the simulation circuitry 302A is increased.

For example, it may be seen as an advantage of the present disclosure that the electronic device disclosed allows the first primary sensor data to be provided both to the inference circuitry and the simulation circuitry. This further allows a validation of the set of configuration parameters used at the simulation circuitry, for example that a certain set of configuration parameters (such as set of configuration parameters of sensor circuitry logic, provided by the learning circuitry), result in an output that corresponds to the first prediction data at the inference circuitry (for example, when the sensor circuitry is an accelerometer, the output may correspond to first prediction data indicative of a movement inferred at the inference circuitry).

In one or more example electronic devices, the set of configuration parameters comprises a set of hardware logic parameters.

In one or more example electronic devices, the generation of the simulated prediction data at the simulation circuitry 302A is based on an emulation of a sensor logic based on the set configuration parameters.

In one or more example electronic devices, the processor circuitry 302 is configured to perform, at a rate faster than a rate at which the first sensor data is obtained, one or more of:
to generate, based on the first primary sensor data, the simulated prediction data at the simulation circuitry 302A;
to generate, based on the simulated prediction data, the second prediction data at the inference circuitry 302B;
obtain, at the simulation circuitry 302A, the set of configuration parameters from the learning circuitry 302C, and
generate the simulated prediction data based on the first primary sensor data and the obtained set of configuration parameters.

One or more of the operations that may be executed at a rate faster that a rate at which the first sensor data is obtained are seen as a learning cycle for improving the operations performed by the simulation circuitry in association with the inference circuitry. It may be appreciated that the learning cycle can run several times without waiting for new first primary sensor data (for example a new movement of an accelerometer). In other words, the rate may for example be at a rate that is 2 times, 3 times, 10 times, 50 times, 100 times, faster that the rate at which the first sensor data is obtained. The rate may be an adaptive rate, such as based on uncertainty of the learning circuitry regarding the actual configuration parameters of the sensor circuitry. For example, the rate of the operations of the simulation circuitry may be performed at a faster rate when the learning circuitry has a higher uncertainty associated with the configuration parameters generated by the learning circuitry. When the learning circuitry has performed one or more learning cycles, the level uncertainty may have been reduced (for example the learning circuitry may have learned the behaviour of the inference circuitry), and the rate may therefore be reduced, for example to reduce the energy consumption.

The rate may for example be more than one time faster than the rate at which the first sensor data is obtained. It may be seen that the disclosed technique allows to converge to optimal configuration parameters faster than ordinary adaptive machine learning.

It may be appreciated that for each learning cycle, the set of configuration parameters are optimized by the learning circuitry. For example, when the set of configuration parameters are related to hardware interrupt, the configuration parameters of the simulation circuitry acting as an interrupt simulator are optimized by the learning circuitry. When the learning circuitry has determined that the configuration parameters are robust (using the comparison for example), the set of configuration parameters are propagated back and replace the old ones in the sensor circuitry (for example the actual sensor logic). The learning circuitry may for example determine that the set of configuration parameters are robust after a certain number of learning cycles. In other words, the learning circuitry may have determined that the configuration parameters are robust when the likelihood of discarding data (such as false negatives) that should have generated inference events is reduced (for example, below a robustness threshold).

Furthermore, the operations of the electronic device may be considered a method that the electronic device is configured to carry out. Also, while the described functions and operations may be implemented in software, such functionality may as well be carried out via dedicated hardware or firmware, or some combination of hardware, firmware and/or software.

In one or more example electronic devices, the electronic device 300A may act as a tracking beacon (such as a LTE connected asset tracking beacon) comprising a memory circuitry, an interface circuitry, and a processor circuitry comprising a simulation circuitry, an inference circuitry, and a learning circuitry. The processor circuitry of the tracking beacon may be configured to obtain first primary sensor data such as tracking data (for example accelerometer measurements) from a sensor circuitry, such as a tracking circuitry (for example an accelerometer). The tracking circuitry. The processor circuitry may further be configured to generate, based on the first primary sensor data, simulated prediction data, such as simulated prediction data related to the tracking circuitry (for example simulated sensor data based on a simulation of the tracking circuitry), at the simulation circuitry.

The processor circuitry may further be configured to generate, based on the first primary sensor data, first prediction data, such as first prediction data related to the tracking circuitry (for example first prediction data indicative of a movement inferred at the inference circuitry), at the inference circuitry. Examples of movements may be a user walking with the tracking circuitry, a user running with the tracking circuitry, and/or the tracking circuitry being dropped with an impact. In turn, the first prediction data may allow to detect specific motion events such as walking, running, and/or a drop with an impact. The first prediction data may further allow to differentiate running from walking, and/or from a drop with an impact. For example, the first prediction data may be indicative of a likelihood and/or a probability that the tracking circuitry has detected that an event corresponding to: a user walking, a user running, and/or a drop with an impact. For example, the first prediction data may be indicative of a prediction of a likelihood that an actual event (such as a motion event like walking, running, or a drop with an impact) is detected based on the first primary sensor data and an inference model. For example, the first prediction data may be indicative of a prediction, a prediction of a likelihood and/or a probability that the tracking circuitry has detected an event corresponding to: a pedestrian movement, a vehicular movement, a stationary state, an orientation state and/or an vertical movement associated with an altitude.

The processor circuitry may further be configured to generate, based on the simulated prediction data, second prediction data, such as second prediction data related to the tracking circuitry, at the inference circuitry. For example, the second prediction data may comprise data resulting from applying an inference model to the simulated prediction data. For example, the second prediction data may be indicative of a prediction of a likelihood that an actual event (such as a motion event like walking, running, or a drop with an impact) is detected based on the simulated prediction data and an inference model.

The processor circuitry may be configured to generate, based on the first prediction data and the second prediction data, a set of configuration parameters, such as a set of configuration parameters related to the tracking circuitry, at the learning circuitry. The processor circuitry may further be configured to provide, to the tracking circuitry, the set of configuration parameters. For example, the set of configuration parameters may comprise a threshold list that may enable the tracking circuitry to be active when moving only.

This may for example allow to provide a tracking beacon (such as a LTE connected asset tracking beacon) that is to be asleep as long as it stationary and is to start transmitting when moving (which may be determined by accelerometer measurements and a threshold list). The present disclosure allows an improvement of battery efficiency of the beacon and an adaptation to the context.

In one or more example electronic devices, the electronic device 300A may act as a mobile device carried by a person comprising a memory circuitry, an interface circuitry, and a processor circuitry comprising a simulation circuitry, an inference circuitry, and a learning circuitry.

The processor circuitry of the mobile device may be configured to obtain first primary sensor data such as brightness data (for example light sensor measurement data) from a sensor circuitry, such as a light sensor circuitry (for example a light sensor).

The processor circuitry of the mobile device may further be configured to generate, based on the first primary sensor data, simulated prediction data, such as simulated prediction data related to the light sensor circuitry (for example simulated sensor data based on a simulation of the light sensor circuitry), at the simulation circuitry. For example, the simulated prediction data may comprise light intensity data (such as lux data), and/or colorimetric data (such as 9700K).

The processor circuitry of the mobile device may further be configured to generate, based on the first primary sensor data, first prediction data, such as first prediction data related to the light sensor circuitry (such as a predicted level of screen brightness), at the inference circuitry.

The processor circuitry of the mobile device may be configured to generate, based on the simulated prediction data, second prediction data, such as second prediction data related to the light sensor circuitry (for example a predicted level of screen brightness), at the inference circuitry. For example, the second prediction data may comprise data resulting from applying an inference model to the simulated prediction data. For example, the second prediction data may be indicative of a prediction of a likelihood that an actual event (such as a light event like level of brightness corresponding to one or more of, for example, inside a box, where it is dark, when a box is opened, letting light in, outside in the daylight, outside having a cloudy sky, and shining sun) is detected based on the simulated prediction data and an inference model.

The processor circuitry of the mobile device may further be configured to generate, based on the first prediction data and the second prediction data, a set of configuration parameters, such as a set of configuration parameters related to the light sensor circuitry (for example light sensor interrupt parameters), at the learning circuitry.

The processor circuitry of the mobile device may further be configured to provide, to the light sensor circuitry, the set of configuration parameters (such as light sensor interrupt parameters). For example, the set of configuration parameters may comprise a threshold list that may enable the light sensor circuitry to be active only when a change in light is occurring.

This may for example allow to provide a mobile device carried by a person, where the display brightness changes multiple times per day. The brightness level is for example determined by the measurements from the light sensor that are input to an inference model of the inference circuitry. The inference model output gives the level of screen brightness. The present disclosure allows to let the light sensor interrupt parameters adapt in order to directly provide the screen brightness level without starting the main processors. Thereby, a reduction of energy consumption and a faster response time are achieved.

FIG. 1B is a block-diagram illustrating an example electronic device 300B according to some embodiments of the present disclosure. The electronic device 300B comprises a memory circuitry 301, a processor circuitry 302 comprising a simulation circuitry 302A, an inference circuitry 302B, and a learning circuitry 302C. The electronic device 300A comprises an interface circuitry 303. The processor circuitry 302 is configured to obtain first primary sensor data from a sensor circuitry 304B. The processor circuitry 302 is configured to generate, based on the first primary sensor data, simulated prediction data at the simulation circuitry 302A. The processor circuitry 302 is configured to generate, based on the first primary sensor data, first prediction data at the inference circuitry 302B. The processor circuitry 302 is configured to generate, based on the simulated prediction data, second prediction data at the inference circuitry 302B. The processor circuitry 302 is configured to generate, based on the first prediction data and the second prediction data, a set of configuration parameters at the learning circuitry 302C. The processor circuitry 302 is configured to provide, to the sensor circuitry 304B, the set of configuration parameters. The sensor circuitry 304B of FIG. 1B is not comprised in the electronic device 300B. The sensor circuitry 304B is configured to communicate with the electronic device 300B for example wirelessly, via a network connection, or via a wired connection.

In one or more example electronic devices, the sensor circuitry 304B is external to the electronic device 300B. In other words, the interface circuitry may be configured to connect the electronic device to the sensor circuitry.

Furthermore, the operations of the electronic device may be considered a method that the electronic device is configured to carry out. Also, while the described functions and operations may be implemented in software, such functionality may as well be carried out via dedicated hardware or firmware, or some combination of hardware, firmware and/or software.

FIG. 2 shows a flow-chart illustrating an example method 100 for adapting one or more configuration parameters for an electronic device (such as the electronic device disclosed herein, such as the electronic device 300A, 300B of FIG. 1A-B).

The electronic device comprises a memory circuitry, an interface circuitry, and a processor circuitry comprising a simulation circuitry (such as simulation circuitry 302A of FIG. 1A-B), an inference circuitry (such as inference circuitry 302B of FIG. 1A-B, and a learning circuitry (such as a learning circuitry 302C of FIG. 1A-B).

The method comprises obtaining S102 first primary sensor data from a sensor circuitry. For example, the first primary sensor data may comprise one or more of: as accelerometer data from a sensor circuitry such as an accelerometer, light data from a photo-sensor, sound (such as voice) data from a microphone, photo or video data from a camera, temperature data from a thermometer, pressure data from a pressure sensor, and humidity data from a hygrometer.

The method comprises generating S104, based on the first primary sensor data, simulated prediction data at the simulation circuitry.

The method comprises generating S106, based on the first primary sensor data, first prediction data at the inference circuitry.

The method comprises generating S108, based on the simulated prediction data, second prediction data at the inference circuitry.

The method comprises generating S110, at the learning circuitry, based on the first prediction data and the second prediction data, a set of configuration parameters. For example, the set of configuration parameters comprises a set of hardware logic parameters.

The method comprises providing S112, to the sensor circuitry, the set of configuration parameters. In one or more example methods, the sensor circuitry is internal to the electronic device. In other words, the electronic device comprises the sensor circuitry. In one or more example methods, the sensor circuitry is external to the electronic device.

In one or more example methods, the method 100 comprises obtaining S114, at the simulation circuitry, the set of configuration parameters from the learning circuitry, and generating S104A the simulated prediction data based on the first primary sensor data and the obtained set of configuration parameters.

In one or more example methods, generating S110, at the learning circuitry, based on the first prediction data and the second prediction data, a set of configuration parameters comprises comparing S110A the first prediction data and the second prediction data.

In one or more example methods, generating S104, based on the first primary sensor data, the simulated prediction data at the simulation circuitry comprises generating S104B the simulated prediction data based on an emulation of a sensor logic which is based on the set configuration parameters.

In one or more example methods, the inference circuitry comprises a first inference circuitry. In one or more example methods, generating S106, based on the first primary sensor data, the first prediction data at the inference circuitry comprises generating S106A, the first prediction data, based on the first primary sensor data and a first inference model associated with the first inference circuitry, first prediction data.

In one or more example methods, the inference circuitry comprises a second inference circuitry. In one or more example methods, generating S106, based on the first primary sensor data, the first prediction data at the inference circuitry comprises generating S106B, the first prediction data based on a second inference model associated with the second inference circuitry.

In one or more example methods, one or more of steps S104, S106, S104A, S114 are performed at a rate faster than a rate at which step S102 is performed.

FIG. 3 is a diagram illustrating an example process for adapting one or more configuration parameters according to one or more embodiments of this disclosure. FIG. 3 shows a sensor circuitry which may be internal 304A or external 304B to the electronic device disclosed herein.

The processor circuitry 302 comprises a simulation circuitry 302A, an inference circuitry 302B, and a learning circuitry 302C.

The processor circuitry 302 is configured to obtain first primary sensor data 306 from the sensor circuitry 304A, 304B. The first primary sensor data 306 may be data such as accelerometer data from a sensor circuitry such as an accelerometer, light data from a photo-sensor, sound (such as voice) data from a microphone, photo or video data from a camera, temperature data from a thermometer, pressure data from a pressure sensor, or humidity data from a hygrometer.

The simulation circuitry 302A is configured to generate, based on the first primary sensor data 306, simulated prediction data 309 and to provide the simulated prediction data 309 to the inference circuitry 302B. The simulation circuitry 302A may be seen as a simulation engine configured to emulate and/or simulate one or more configurations of the sensor logic to generate the simulated prediction data (such as simulated sensor data, based on for example interrupt parameter(s) and/or threshold logic parameter(s)). The inference circuitry 302B is configured to generate, based on the simulated prediction data 309, second prediction data 310 and to provide the second prediction data 310 to the learning circuitry 302C.

The inference circuitry 302B is configured to generate, based on the first primary sensor data 306, first prediction data 308 and to provide the first prediction data 308 to the learning circuitry 302C. The inference circuitry 302B may be seen as an inference engine configured to perform an inference derivation (such as a statistical inference derivation) such as based on an inference model. The inference engine may for example perform or run predictions using both first primary sensor data 306 (such as actual sensor data (for example real-time sensor data) from the sensor circuitry 304A, 304B) and simulated prediction data 309. In some embodiments, the inference circuitry 302B may be configured as a black-box element, for example as an element of which operations are not transparent to an entity external to the black-box element.

The learning circuitry 302C is configured to generate, based on the first prediction data 308 and the second prediction data 310, a set of configuration parameters 312. In some embodiments, the learning circuitry 302C may be seen as a learning engine configured to tune the set of configuration parameters 312. In one or more example electronic devices, the generation of the set of configuration parameters at the learning circuitry 302C is based on a comparison of the first prediction data 308 and the second prediction data 310. In one or more example electronic devices, the set of configuration parameters comprises a set of hardware parameters and/or a set of software parameters.

The learning circuitry 302C is configured to provide, to the sensor circuitry 304A, 304B, the set of configuration parameters 312.

The learning circuitry 302C is optionally configured to provide, to the simulation circuitry 302A, the set of configuration parameters 312 and/or an additional set of configuration parameters 312A which may be different the set of configuration parameters. In one or more example electronic devices, the simulation circuitry 302A is configured to generate the simulated prediction data 309 based on the first primary sensor data 306 and the obtained set of configuration parameters 312, 312A.

In one or more example electronic devices, the generation of the simulated prediction data 309 at the simulation circuitry 302A is based on an emulation of a sensor logic based on the set configuration parameters 312, 312A.

In one or more example electronic devices, the inference circuitry 302B comprises a first inference circuitry 30266. In one or more example electronic devices, the generation of the first prediction data 308A at the inference circuitry 302B is further based on a first inference model associated with the first inference circuitry 302BB and optionally based on first simulated prediction data 309A.

In one or more example electronic devices, the inference circuitry 302B comprises a second inference circuitry 302BC. In one or more example electronic devices, the generation of the first prediction data 308B at the inference circuitry 302B is further based on a second inference model associated with the second inference circuitry 302BC and optionally based on second simulated prediction data 309B.

In one or more example electronic devices, the inference circuitry 302B comprises a third inference circuitry 302BD. In one or more example electronic devices, the generation of the first prediction data 308C at the inference circuitry 302B is further based on a third inference model associated with the third inference circuitry 302BD and optionally based on third simulated prediction data 309C.

In an illustrative example where the disclosed technique is applied to speech recognition, the first inference model may be related to voice detection, the second inference model may be related to keyword detection, and the third inference model may be related to sentence detection. For example, the first inference circuitry 302BB may be seen as an inference circuitry for voice detection. For example, the second inference circuitry 302BC may be seen as an inference circuitry for keyword detection. For example, the third inference circuitry 302BD may be seen as an inference circuitry for sentence detection. In some embodiments, the optimization may be run from third inference circuitry 302BD to the first inference circuitry 302BB. For example, the first optimization may run on the third inference circuitry 302BD until completion, then this third model can be used to optimize the second inference mode. This may continue until we have reached the first inference model associated with the first inference circuitry 302BB.

The set of configuration parameters may comprise a hardware interrupt parameter related to the first inference model related to voice detection, for example to wake-up a microphone acting as the sensor circuitry to start listening. The set of configuration parameters may comprise a keyword parameter related to the second inference model related to keyword detection, for example in order to activate the second inference circuitry, which may be configured to be more complex than the first inference model, for example such that actual words may be detected more precisely. The set of configuration parameters may comprise a sentence parameter related to the third inference model related to sentence detection, for example in order to activate the third inference model, which may be configured to be more complex than the second inference model, for example such that actual sentences may be detected more precisely.

The first inference model, the second inference model, and the third inference model may for example be related to a first state, a second state, and a third state respectively. The states may for example comprise a dormant state, a low active state, a middle active state, and/or a highly active state. In some examples, the inference models may be related to one or more states. The first inference model may for example be related to a dormant state when no voice is detected and then to an active state when voice is detected. The present disclosure may thereby allow to let the set of configuration parameters adapt in order to directly provide the speech detection without starting the main processors. Thereby, a reduction of energy consumption and a faster response time are achieved.

In an illustrative example where the disclosed technique is applied to speech recognition, the processor circuitry 302 of the electronic device may be configured to obtain first primary sensor data 306 such as sound data (for example sound measurements) from a sensor circuitry 304A, 304B, such as a microphone circuitry. The processor circuitry 302 may further be configured to generate, based on the first primary sensor data 306, simulated prediction data 309, such as simulated prediction data 309 related to the microphone circuitry (for example simulated sensor data based on a simulation of the microphone circuitry), at the simulation circuitry 302A.

The processor circuitry 302 may further be configured to generate, based on the first primary sensor data 306, first prediction data 308, such as first prediction data 308 related to the microphone circuitry (for example first prediction data indicative of a sound, a voice, a keyword and/or sentence inferred at the inference circuitry), at the inference circuitry. For example, the first prediction data 308 may be indicative of a likelihood and/or a probability that the microphone circuitry has detected that a sound corresponding to a voice (such as a phoneme), a keyword, and/or a sentence. For example, the first prediction data 308 may be indicative of a prediction of a likelihood that an actual sound is detected based on the first primary sensor data 306 and an inference model.

The processor circuitry 302 may further be configured to generate, based on the simulated prediction data 309, second prediction data 310, such as second prediction data 310 related to the microphone circuitry, at the inference circuitry. For example, the second prediction data 310 may comprise data resulting from applying an inference model to the simulated prediction data 309. For example, the second prediction data 310 may be indicative of a prediction of a likelihood that an actual sound corresponding to a voice (such as a phoneme), a keyword, and/or a sentence is detected based on the simulated prediction data and an inference model.

The processor circuitry 302 may be configured to generate, based on the first prediction data 308 and the second prediction data 310, a set of configuration parameters 312, such as a set of configuration parameters related to the microphone circuitry, at the learning circuitry. The processor circuitry 302 may further be configured to provide, to the microphone circuitry, the set of configuration parameters 312. For example, the set of configuration parameters may comprise a threshold list that may enable the microphone circuitry 304A, 304B to be active when detecting a sound, possibly associated with sufficient confidence probability.

Embodiments of devices (electronic devices) and methods according to the disclosure are set out in the following items:

Item 1. An electronic device (300A, 300B) comprising:
a memory circuitry (301);
a processor circuitry (302) comprising a simulation circuitry (302A), an inference circuitry (302B), and a learning circuitry (302C);
an interface circuitry (303);
the processor circuitry (302) being configured to:
obtain first primary sensor data from a sensor circuitry (304A, 304B);
generate, based on the first primary sensor data, simulated prediction data at the simulation circuitry (302A);
generate, based on the first primary sensor data, first prediction data at the inference circuitry (302B);
generate, based on the simulated prediction data, second prediction data at the inference circuitry (302B);
generate, based on the first prediction data and the second prediction data, a set of configuration parameters at the learning circuitry (302C); and
provide, to the sensor circuitry (304A, 304B), the set of configuration parameters.

Item 2. The electronic device (300A, 300B) according to item 1, wherein the sensor circuitry (304A, 304B) is internal to the electronic device (300A), or external to the electronic device (300B).

Item 3. The electronic device (300A, 300B) according to any one of items 1-2, wherein the processor circuitry (302) is configured to:
obtain, at the simulation circuitry (302A), the set of configuration parameters from the learning circuitry (302C), and
generate the simulated prediction data based on the first primary sensor data and the obtained set of configuration parameters.

Item 4. The electronic device (300A, 300B) according to any one of items 1-3, wherein the generation of the set of configuration parameters at the learning circuitry (302C) is based on a comparison of the first prediction data and the second prediction data.

Item 5. The electronic device (300A, 300B) according to any one of items 1-4, wherein the set of configuration parameters comprises a set of hardware logic parameters.

Item 6. The electronic device (300A, 300B) according to any one of items 1-5, wherein the generation of the simulated prediction data at the simulation circuitry (302A) is based on an emulation of a sensor logic based on the set configuration parameters.

Item 7. The electronic device (300A, 300B) according to any one of items 1-6, wherein the inference circuitry (302B) comprises a first inference circuitry, the generation of the first prediction data at the inference circuitry (302B) is further based on a first inference model associated with the first inference circuitry.

Item 8. The electronic device (300A, 300B) according to any one of items 1-7, wherein the inference circuitry (302B) comprises a second inference circuitry, the generation of the first prediction data at the inference circuitry (302B) is further based on a second inference model associated with the second inference circuitry.

Item 9. The electronic device (300A, 300B) according to any one of items 1-8 as dependent on item 3, wherein the processor is configured to perform, at a rate faster than a rate at which the first sensor data is obtained, one or more of:
generate, based on the first primary sensor data, the simulated prediction data at the simulation circuitry (302A);
generate, based on the simulated prediction data, the second prediction data at the inference circuitry (302B);
obtain, at the simulation circuitry (302A), the set of configuration parameters from the learning circuitry (302C), and
generate the simulated prediction data based on the first primary sensor data and the obtained set of configuration parameters.

Item 10. A method for adapting one or more configuration parameters for an electronic device (300A, 300B) comprising, a memory circuitry (301), an interface circuitry, and a processor circuitry (302) comprising a simulation circuitry (302A), an inference circuitry (302B), and a learning circuitry (302C), the method comprising:
obtaining (S102) first primary sensor data from a sensor circuitry (304A, 304B);
generating (S104), based on the first primary sensor data, simulated prediction data at the simulation circuitry (302A);
generating (S106), based on the first primary sensor data, first prediction data at the inference circuitry (302B);
generating (S108), based on the simulated prediction data, second prediction data at the inference circuitry (302B);
generating (S110), at the learning circuitry (302C), based on the first prediction data and the second prediction data, a set of configuration parameters; and
providing (S112), to the sensor circuitry (304A, 304B), the set of configuration parameters.

Item 11. The method according to item 10, wherein the sensor circuitry (304A, 304B) is internal to the electronic device (300A), or external to the electronic device (300B).

Item 12. The method according to any one of items 10-11, the method comprising:
obtaining (S114), at the simulation circuitry (302A), the set of configuration parameters from the learning circuitry (302C), and
generating (S104A) the simulated prediction data based on the first primary sensor data and the obtained set of configuration parameters.

Item 13. The method according to any one of items 10-12, wherein generating (S110), at the learning circuitry (302C), based on the first prediction data and the second prediction data, a set of configuration parameters comprises comparing (S110A) the first prediction data and the second prediction data.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1A-3 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the example embodiments may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

What is claimed is:

1. An electronic device comprising:
a memory circuitry;
a processor circuitry comprising a simulation circuitry, an inference circuitry, and a learning circuitry;
an interface circuitry;
the processor circuitry being configured to:
obtain first primary sensor data from a sensor circuitry;
generate, based on the first primary sensor data, simulated prediction data at the simulation circuitry;
generate, based on the first primary sensor data, first prediction data at the inference circuitry;
generate, based on the simulated prediction data, second prediction data at the inference circuitry;
generate, based on the first prediction data and the second prediction data, a set of configuration parameters at the learning circuitry; wherein the generation of the set of configuration parameters at the learning circuitry is based on a comparison of the first prediction data and the second prediction data;
obtain, at the simulation circuitry, the set of configuration parameters from the learning circuitry;
generate the simulated prediction data based on the first primary sensor data and the obtained set of configuration parameters; and
provide, to the sensor circuitry, the set of configuration parameters.

2. The electronic device according to claim 1, wherein the sensor circuitry is internal to the electronic device, or external to the electronic device.

3. The electronic device according to claim 1, wherein the set of configuration parameters comprises a set of hardware logic parameters.

4. The electronic device according to claim 1, wherein the generation of the simulated prediction data at the simulation circuitry is based on an emulation of a sensor logic which is based on the set configuration parameters.

5. The electronic device according to claim 1, wherein the inference circuitry comprises a first inference circuitry, the generation of the first prediction data at the inference circuitry is further based on a first inference model associated with the first inference circuitry.

6. The electronic device according to claim 1, wherein the inference circuitry comprises a second inference circuitry, the generation of the first prediction data at the inference circuitry is further based on a second inference model associated with the second inference circuitry.

7. The electronic device according to claim 1, wherein the processor is configured to perform, at a rate faster than a rate at which the first sensor data is obtained, one or more of:
generate, based on the first primary sensor data, the simulated prediction data at the simulation circuitry;
generate, based on the simulated prediction data, the second prediction data at the inference circuitry;
obtain, at the simulation circuitry, the set of configuration parameters from the learning circuitry, and
generate the simulated prediction data based on the first primary sensor data and the obtained set of configuration parameters.

8. A method for adapting one or more configuration parameters for an electronic device comprising a memory circuitry, an interface circuitry, and a processor circuitry comprising a simulation circuitry, an inference circuitry, and a learning circuitry, the method comprising:
obtaining first primary sensor data from a sensor circuitry;
generating, based on the first primary sensor data, simulated prediction data at the simulation circuitry;
generating, based on the first primary sensor data, first prediction data at the inference circuitry;
generating, based on the simulated prediction data, second prediction data at the inference circuitry;
generating, at the learning circuitry, based on the first prediction data and the second prediction data, a set of configuration parameters;
wherein generating, at the learning circuitry, based on the first prediction data and the second prediction data, the set of configuration parameters comprises comparing the first prediction data and the second prediction data
obtaining, at the simulation circuitry, the set of configuration parameters from the learning circuitry,
generating the simulated prediction data based on the first primary sensor data and the obtained set of configuration parameters and
providing, to the sensor circuitry, the set of configuration parameters.

9. The method according to claim 8, wherein the sensor circuitry is internal to the electronic device, or external to the electronic device.
